(19) United States
(12) Patent Application Publication
(10) Pub. No.: US 2025/0219643 A1
(43) Pub. Date: Jul. 3, 2025

(54) HIGHLY SCALABLE ENTROPY SOURCE

(71) Applicant: Intel Corporation, Santa Clara, CA (US)

(72) Inventors: Rachael Parker, Forest Grove, OR (US); Shavali Alisher, Portland, OR (US); Avinash Murugesan, Hillsboro, OR (US)

(21) Appl. No.: 18/398,916

(22) Filed: Dec. 28, 2023

(51) Int. Cl. H03K 19/20; H03K 3/037; H04L 9/08

(52) U.S. Cl. CPC H03K 19/20; H03K 3/037; H04L 9/0869

(57) ABSTRACT

An apparatus configured as an entropy source circuit includes a bistable circuit, a first latch circuit, a charge pump circuit, and an oscillator circuit. The bistable circuit generates random bits based on an input clock signal and a plurality of voltage adjustment signals. The first latch circuit is coupled to the bistable circuit and generates entropy bits based on the random bits. The charge pump circuit is coupled to the latch circuit and generates the plurality of voltage adjustment signals based on the entropy bits and a plurality of clock phases (e.g., a redistribute clock signal and a precharge clock signal). The entropy source circuit can be coupled in a ring topology with a plurality of other entropy source circuits, where the plurality of clock phases can be generated based on output clock signals received from at least one of the plurality of other entropy source circuits.

### BACKGROUND

With increasing demand for secure computing and data transactions, the demand on silicon for cryptographic quality random numbers at a high data rate is increasing. A digital random number generator (DRNG) provides two types of random numbers. The first is a cryptographically secure non-deterministic random number via a non-deterministic random bit generator (NRBG), and the second is a cryptographically secure deterministic random number via a deterministic random bit generator (DRBG). Both of these are derived from the output of a NIST SP800-90B compliant entropy source (ES).

An NRBG can provide random numbers at a rate of ˜10 MB/s, whereas a DRBG can provide random numbers at a rate of up to 2 GB/s. In order to meet this data rate, the ES is targeted to output random bits at a rate of approximately 1.6 Gb/s. This allows a 1:4 decimation of the ES bitstream and a 1:4 conditioning/extraction ratio to get an output with ˜100% entropy at a rate fast enough to reseed the DRBG with the conditioned ES output. However, the DRBG is not quantum safe. The cryptographic security of the DRBG output depends on not being able to predict the pseudo-random sequence within the allotted time between re-seeds. This is not ensured with quantum computing, and a solution can be to remove the DRBG and use the NRBG. However, such a solution can cause a significant loss in performance. Additionally, existing ES solutions lack scalability with a low area that can be instantiated multiple times to meet the requirements of different applications/segments.

### BRIEF DESCRIPTION OF THE DRAWINGS

In the drawings, like numerals may describe the same or similar components or features in different views. Like numerals having different letter suffixes may represent different instances of similar components. Some embodiments are illustrated by way of example, and not limitation, in the figures of the accompanying drawings in which:

FIG. 1 is a block diagram of a NOR gate unit cell, in accordance with some embodiments;

FIG. 2 is a block diagram of parallel NOR gate unit cells, in accordance with some embodiments;

FIG. 3 is a block diagram of a bistable circuit using cross-coupled NOR gate unit cells, in accordance with some embodiments;

FIG. 4 is a block diagram of a differential buffer, in accordance with some embodiments;

FIG. 5A is a block diagram of a heart circuit of an entropy source using the circuits of FIG. 3 and FIG. 4, in accordance with some embodiments;

FIG. 5B is a block diagram of the heart circuit of FIG. 5A including an SR latch, in accordance with some embodiments;

FIG. 5C is a block diagram of the heart circuit of FIG. 5B including input and output clocks, in accordance with some embodiments;

FIG. 5D is a signal timing diagram of the signals used in FIG. 5C, in accordance with some embodiments;

FIG. 6 is a block diagram of a charge pump, in accordance with some embodiments;

FIG. 7 is a block diagram of another charge pump, in accordance with some embodiments;

FIG. 8 is a block diagram of a closed loop circuit generating entropy source data, in accordance with some embodiments;

FIG. 9 is a signal timing diagram of the signals used in FIG. 8, in accordance with some embodiments;

FIG. 10 is a block diagram of a self-oscillating entropy source, in accordance with some embodiments;

FIG. 11 is a signal timing diagram of the signals used in FIG. 10, in accordance with some embodiments;

FIG. 12A and FIG. 12B illustrate block diagrams of startup circuits that can be used with the disclosed entropy sources, in accordance with some embodiments;

FIG. 13 is a block diagram of an entropy source using a startup circuit, in accordance with some embodiments;

FIG. 14 is a block diagram of the symbol view for the entropy source of FIG. 13, in accordance with some embodiments;

FIG. 15 is a signal timing diagram for a 5-stage ring topology using a disclosed entropy source, in accordance with some embodiments;

FIG. 16 is a block diagram of a 5-stage ring topology using a disclosed entropy source, in accordance with some embodiments;

FIG. 17 is a signal timing diagram for a 4-stage ring topology using a disclosed entropy source, in accordance with some embodiments;

FIG. 18 is a block diagram of a 4-stage ring topology using a disclosed entropy source, in accordance with some embodiments;

FIG. 19 is a block diagram of an entropy source using a capacitive voltage divider for common mode voltage feedback, in accordance with some embodiments;

FIG. 20 is a flow diagram of an example method for generating entropy source data, in accordance with some embodiments; and

FIG. 21 illustrates a block diagram of an example machine upon which any one or more of the operations/techniques (e.g., methodologies) discussed herein may perform.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc., to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail.

The following description and the drawings sufficiently illustrate specific embodiments to enable those skilled in the art to practice them. Other embodiments may incorporate structural, logical, electrical, process, and other changes. Portions and features of some embodiments may be included in or substituted for those of other embodiments. Embodiments outlined in the claims encompass all available equivalents of those claims.

As used herein, the term “chip” (or die) refers to a piece of a material, such as a semiconductor material, that includes a circuit, such as an integrated circuit or a part of an integrated circuit. The term “memory IP” indicates memory intellectual property. The terms “memory IP,” “memory device,” “memory chip,” and “memory” are interchangeable.

The term “processor” configured to carry out specific operations includes both a single processor configured to carry out all of the operations (e.g., operations or methods disclosed herein) as well as multiple processors individually configured to carry out some or all of the operations (which may overlap) such that the combination of processors carry out all of the operations.

Current ES solutions do not produce 100% entropy across different environmental conditions and high volumes; therefore, a conditioner circuit is often used, which reduces the entropy requirement of the digital noise source by an amount depending on the extraction ratio.

The disclosed ES-related techniques can be used to configure an ES. Additionally, the disclosed ES-related techniques are scalable, allowing instantiation of copies and running at a supply voltage that provides a target bit rate while minimizing power, area, or both. The disclosed ES-related techniques allow the acquiring of random seeds (RDSEED instruction) at a higher data rate than existing ES solutions. The random seed data can be used to seed DRBGs or replace the DRBGS that are causing the deterministic output of the faster RDRAND (DRBG) instruction with NRBGs

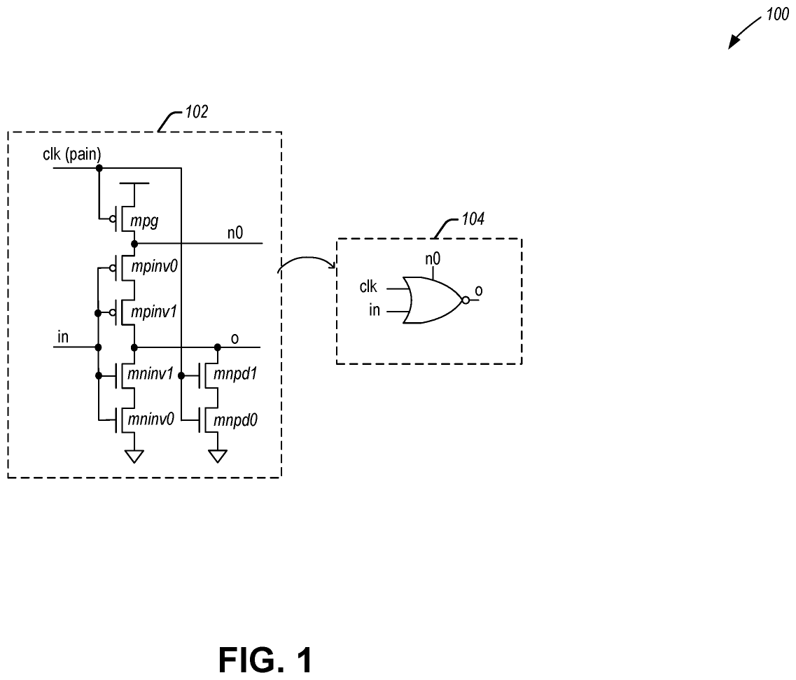

FIG. 1 is a block diagram 100 of a NOR gate unit cell 102, in accordance with some embodiments. In some aspects, an RNG gets its randomness from a bistable circuit comprised of unit cells (e.g., the NOR gate unit cell 102), which are topologically the same as a NOR gate (e.g., NOR gate 104).

Some of the transistors in the NOR gate unit cell 102 can be configured as stacked MOS devices (e.g., two or more MOS transistors coupled with source and drain in series with a common gate connection). For example, mpinv0 and mpinv1 are stacked PMOS transistors. The stacking can be considered part of transistor sizing where stacked transistors are used to get an effectively longer channel length than available with a single MOS device.

The transistors discussed herein can be comprised of a single MOS transistor, or multiple MOS transistors connected either in series or parallel without changing the nature of the present disclosure.

The NOR gate unit cell 102, in this instance, also brings the intermediate node n0 between the two series PMOS transistors out as a pin. This is optional and part of the specific implementation, but removing this pin would not change the nature of the present disclosure.

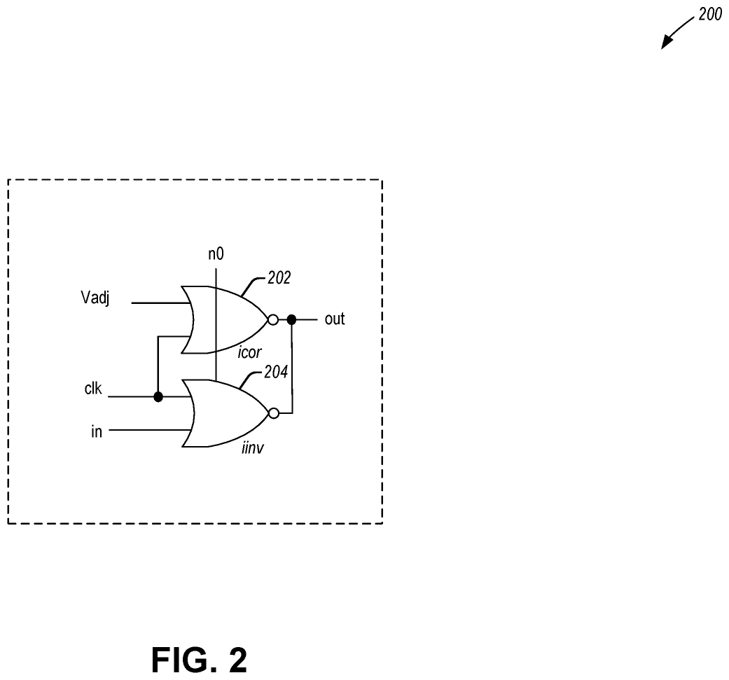

FIG. 2 is a block diagram of circuit 200 formed by parallel NOR gate unit cells, in accordance with some embodiments. Referring to FIG. 2, two NOR gate unit cells from FIG. 1 (e.g., NOR gate unit cells 202 and 204) are coupled in a parallel combination such that their outputs out are shorted to form circuit 200. One input of each NOR gate is tied to a common clock signal clk. The other inputs of the two NOR gates are tied to an input signal in and an analog signal Vadj (e.g., a voltage adjustment signal) respectively. Circuit 200 is also referred to as a heart pair circuit. The nodes n0 from each NOR gate are connected. However, the connection of nodes n0 is optional, and removing this connection would not change the nature of the present disclosure. In this regard, one of the NOR gate unit cells in circuit 200 is used digitally, and the other is used as an analog “corrector” to adjust the effective trip point.

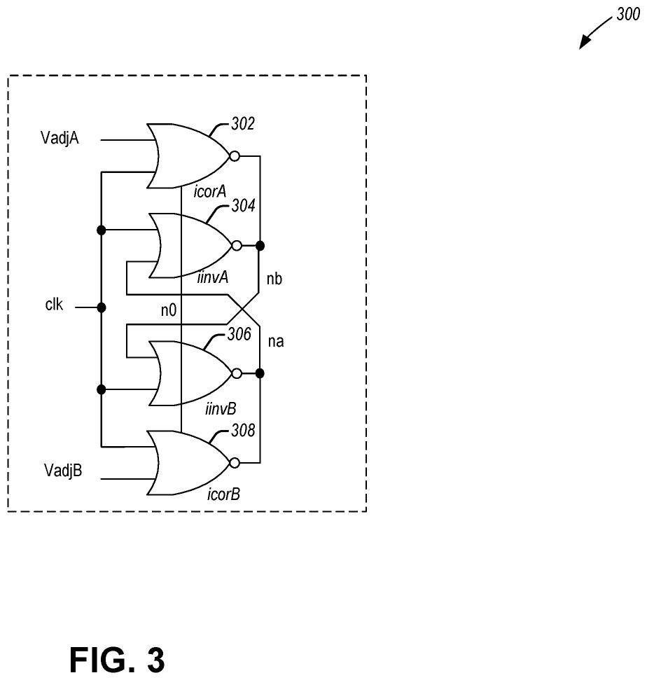

FIG. 3 is a block diagram of a bistable circuit 300 using cross-coupled NOR gate unit cells, in accordance with some embodiments. Referring to FIG. 3, in order to create the bistable circuit 300, two of the heart pair circuits from FIG. 2 (e.g., formed by NOR gate unit cells 302 (or icorA), 304 (or iinvA), 306 (or iinvB), and 308 (or icorB)) are cross-coupled such that the output out of one is driving the input in of the other and vice versa. The NOR gates iinvA and iinvB can be recognized as forming a set-reset latch with the set and reset inputs tied to a common clock signal clk.

The other NOR gates, icorA and icorB, are coupled to iinvA and iinvB, respectively, such that one input is connected to the common clk signal and the other is connected to an analog input voltage VadjA or VadjB respectively. The operation of this circuit is shown in Table 1 below, for the case where all transistors in the “A” NOR gates are perfectly matched with their respective counterparts in the “B” NOR gates.

TABLE 1

| clk | VadjA, VadjB | na | nb |
|---|---|---|---|
| 1 | X | 0 | 0 |
| 0 | VadjA > VadjB | 1 | 0 |
| 0 | VadjA = VadjB | X | X |
| 0 | VadjA < VadjB | 0 | 1 |

As seen in Table 1, when the clk input is 1 (e.g., 1=logical “high”=VCC, 0=logical “low”=VSS), both outputs na and nb are 0 because all four NOR gates have at least one input that is 1. When the clk input is 0, the outputs na and nb can be determined by the relationship between the voltages VadjA and VadjB.

In some aspects, the operation of the bistable circuit 300 is dynamic. In embodiments when clk is 1, na and nb are 0. In embodiments when clk transitions to 0 (falling edge), the nodes na and nb will transition to a metastable state if all transistors are matched and VadjA=VadjB. Transistor noise, such as thermal or flicker noise, can cause the circuit to leave its metastable state, and na and nb can randomly move to 1, 0, or 0, 1, which are stable states. This is the desired cell behavior, which produces a bit with a random outcome determined by a physical process after every falling edge of clk.

However, if there is a sufficient mismatch, such as a difference in threshold voltage between the MOS devices in the NOR gates and VadjA=VadjB, the circuit will move directly and deterministically to one of the stable states 0, 1 or 1, 0 with every falling edge of clk and there will be no randomness. In this case, the voltages VadjA and VadjB can be adjusted differentially to compensate for the mismatch and ensure that transistor noise is still a determining factor in the final output state.

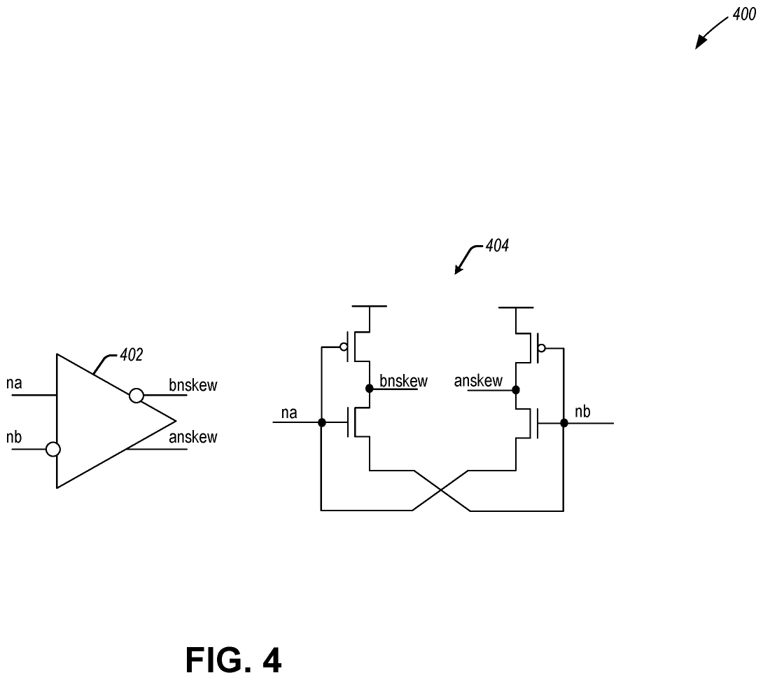

FIG. 4 is a block diagram 400 of a differential buffer 402, in accordance with some embodiments. In some aspects, differential buffer 402 coupled to nodes na and nb can be used to detect when the circuit in FIG. 3 is in a stable state. As used herein, the term “stable state” indicates a state that will be the outcome after being initialized to an unstable state and moving through the metastable state. The unstable and metastable states can be detected when the voltage of na is approximately equal to the voltage of nb. To detect when the circuit is not in an unstable or metastable state, a determination is made on whether na and nb differ by more than a certain amount.

The differential buffer 402 can be configured as circuit 404, which operates as follows. When both na and nb are 0, which is the case when the clk input to the heart circuit is 1, both bnskew and anskew are pulled to 1 by the PMOS transistors. As na and nb move to the metastable state but stay approximately at equal potential, neither of the NMOS transistors has a positive Vgs in order to pull down bnskew or anskew so the nodes remain 1. Once there is a differential voltage between na and nb that is sufficient to turn on one of the NMOS transistors, either bnskew or anskew can be pulled down.

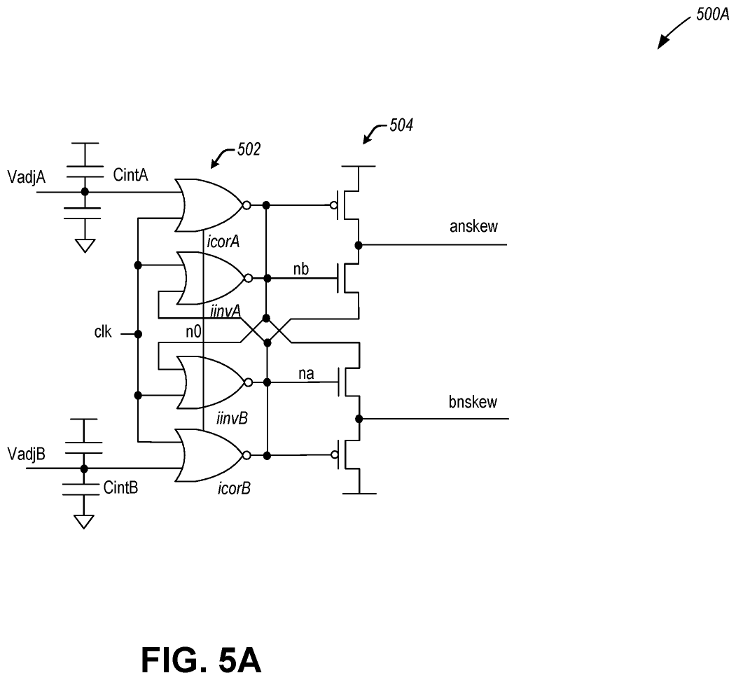

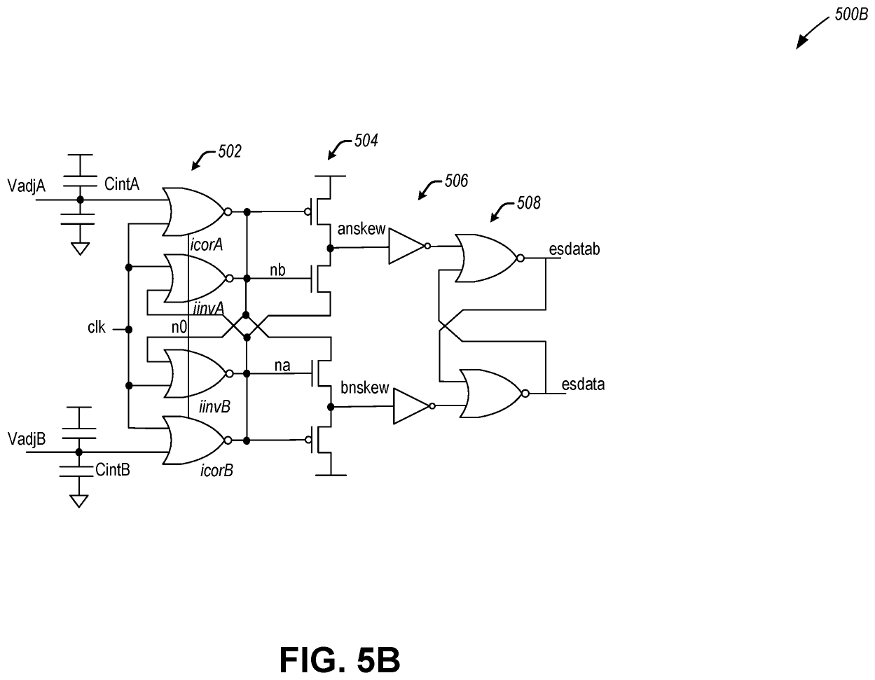

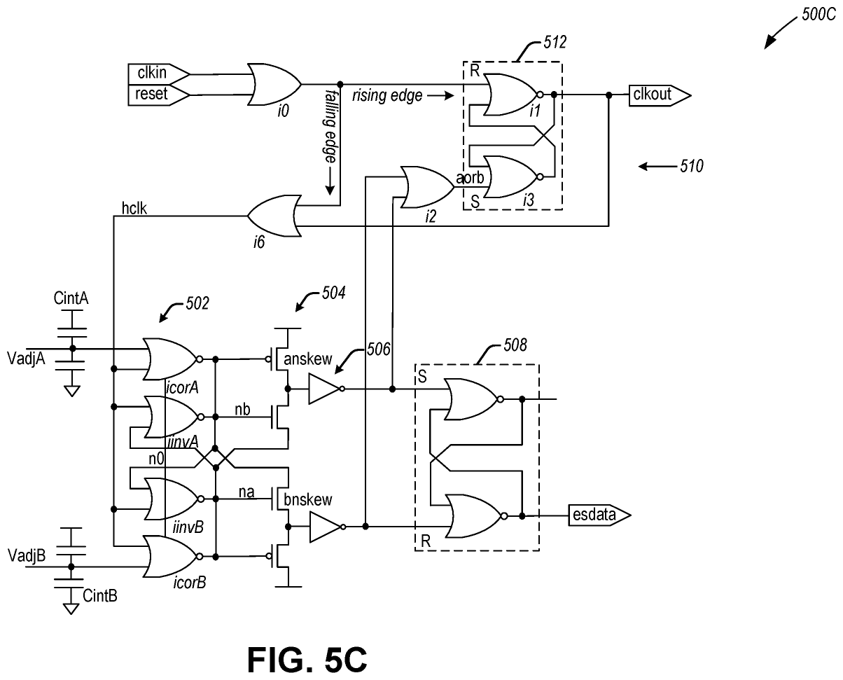

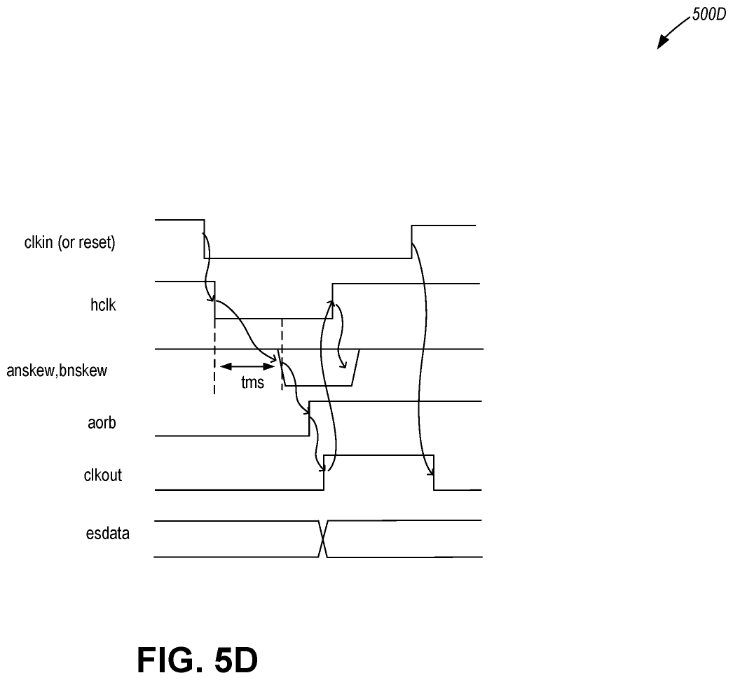

FIG. 5A is a block diagram of a heart circuit 500A of an entropy source using the circuits of FIG. 3 and FIG. 4, in accordance with some embodiments. Referring to FIG. 5A, the heart circuit 500A includes a bistable circuit 502 (e.g., as illustrated in FIG. 3) and a differential buffer 504 (e.g., as illustrated in FIG. 4).

Because of the inversion from the differential buffer 504, the outputs bnskew and anskew will be 1 when clk is 1. On the falling edge of clk, either anskew or bnskew will transition to 0. In order to configure a complete entropy source, a clock and a circuit to drive the VadjA and VadjB analog voltages can be added to compensate for the naturally occurring device variation. Voltages VadjA and VadjB (also referred to as voltage adjustment signals) are stored on capacitors CintA and CintB, respectively. These capacitors are shown to be coupled to both VCC and VSS. In some embodiments, these capacitors can be coupled to either or both supplies or to a reference voltage without changing the nature of the disclosed techniques.

FIG. 5B is a block diagram of heart circuit 500B based on the heart circuit of FIG. 5A and including an SR latch, in accordance with some embodiments. Referring to FIG. 5B, inverters 506 and SR latch 508 are added to the output of the differential buffer 504. Output signals anskew and bnskew are inverted before going into the latch inputs. The output of the SR latch 508 forms the complimentary digital signal esdata and esdatab, which signals can be used as entropy source data (e.g., entropy bits). With the addition of the SR latch 508, heart circuit 500B becomes “edge-triggered” in a similar way that a latch can be made into an edge-trigged flip-flop by adding another latch in series.

FIG. 5C is a block diagram of a heart circuit 500C based on the heart circuit of FIG. 5B including input and output clocks, in accordance with some embodiments. Referring to FIG. 5C, heart circuit 500C differs from the heart circuit 500B by having a clock generation circuit 510, including SR latch 512.

FIG. 5C shows the addition of input and output clocks (clkin, clkout) and reset to make a complete heart cell. Another SR latch (e.g., SR latch 512) is added to keep the state out as signal clkout. Signal clkout can be reset to 0 on the rising edge of clkin. While clkin remains 1, the input hclk to the bistable circuit will be 1, and the bistable circuit will be held in its reset state. This will result in the node aorb being 0, indicating that the circuit has not exited reset or metastability.

On the falling edge of clkin, the signal clkout will be set to 1 only after aorb becomes 1. In this manner, the time to exit reset and the metastable state determines the delay between clkin falling edge and clkout rising edge along with the latch delay. The clkin rising edge to clkout falling edge delay can be determined by the latch delay. Signal reset behaves the same as clkin.

FIG. 5D is a signal timing diagram 500D of the signals used in FIG. 5C, in accordance with some embodiments. Referring to FIG. 5D, the falling edge of clkin results in the bistable circuit producing a rising edge of clkout and a new value of esdata. The rising edge of clkin resets the output clkout.

The signal hclk, which is the clock input to the bistable circuit, will go low (0) long enough for the bistable circuit to exit reset and metastability, and then it will asynchronously go back high (1). This feedback results in the crossbar current caused by the NOR gates icorA and icorB to be limited to the minimum possible duration as opposed to leaving the current flow for the full low phase of clkin.

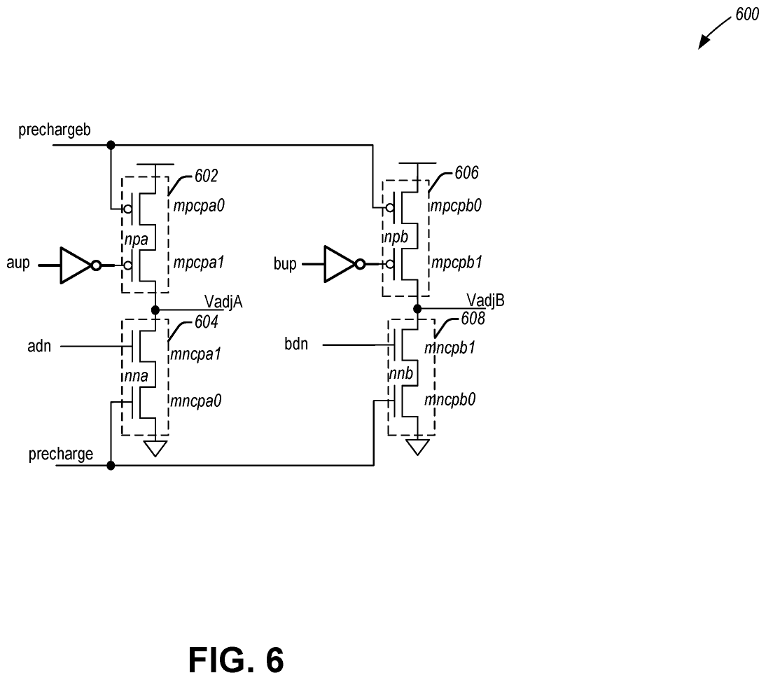

FIG. 6 is a block diagram of a charge pump 600, in accordance with some embodiments. Referring to FIG. 6, each pair of transistors indicated by the dashed boxes (e.g., transistor pairs 602, 604, 606, and 608) form a switched capacitor resistor. The two MOS devices form the switches (e.g., mncpa1 and mncpa0), and the parasitic capacitance of the shared diffusion between the two MOS devices (e.g., nna) forms the sampling capacitor. This circuit operates in two phases. During the first phase, the nodes precharge and prechargeb are 1 and 0, respectively, causing mpcpa0 and mpcpb0 to charge npa and npb to VCC, and causing mncpa0 and mncpb0 to charge nna and nnb to VSS. Inputs aup, adn, bup, and bdn are all 0, so mpcpa1, mpcpb1, mncpa1, and mncpb1 are OFF, isolating npa, npb, bna, and nnb from the outputs VadjA and VadjB.

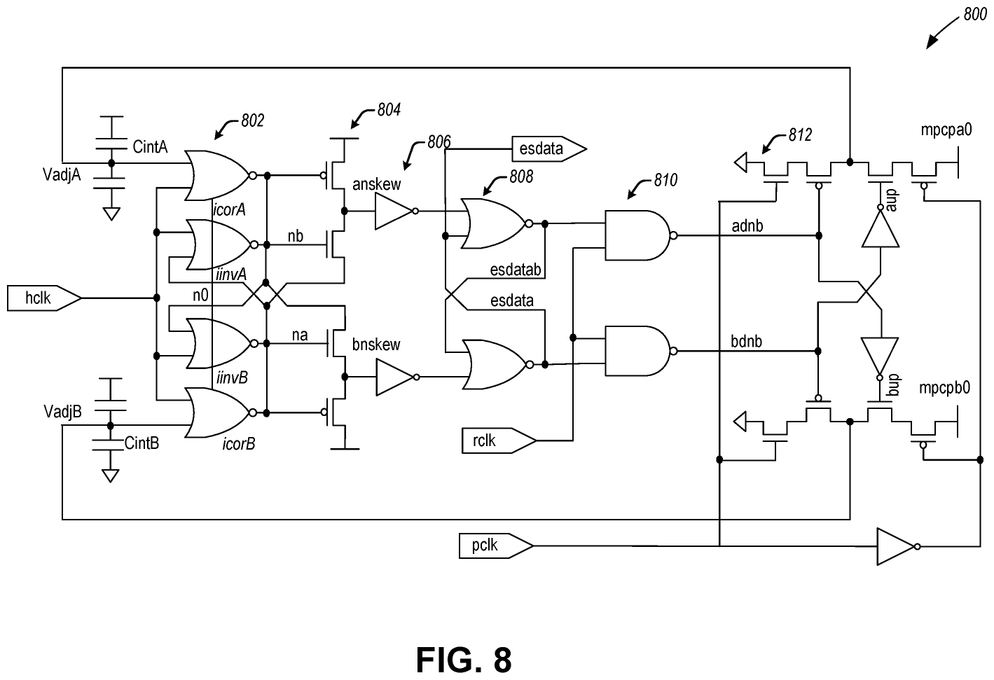

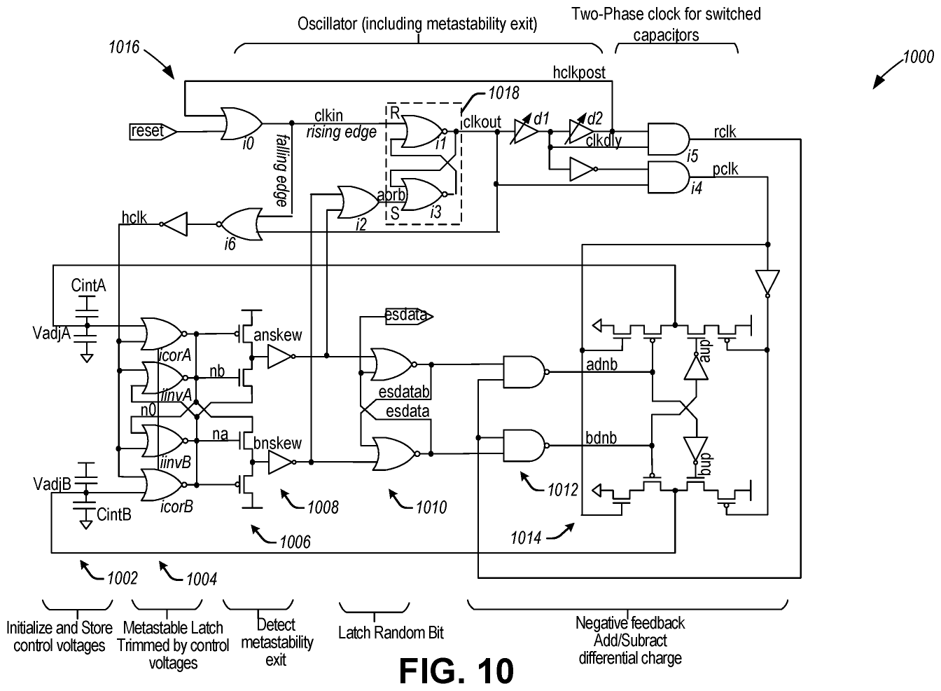

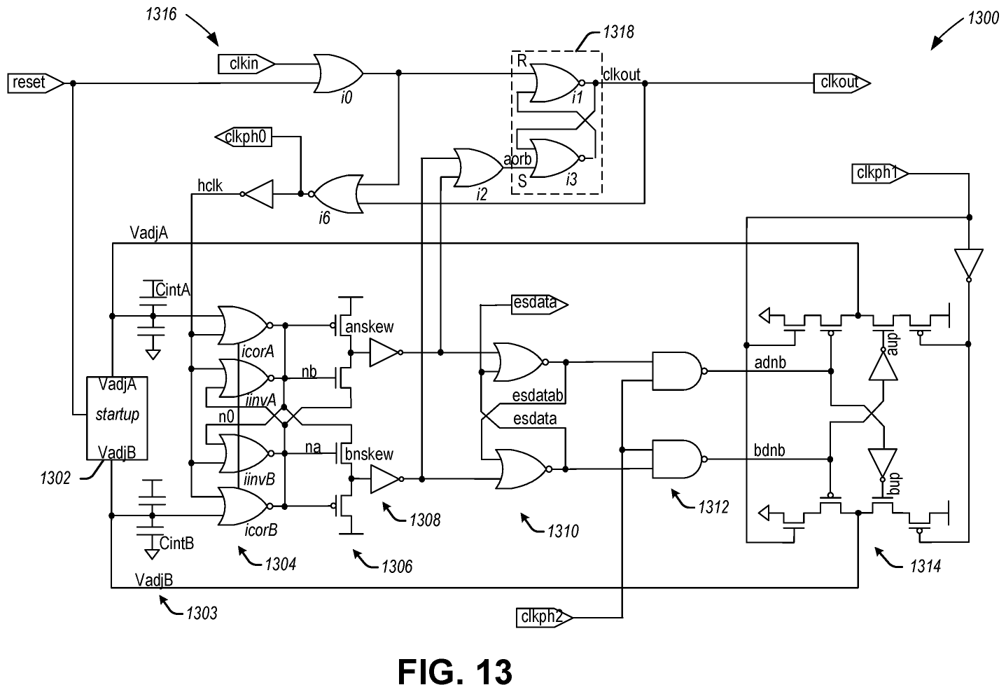

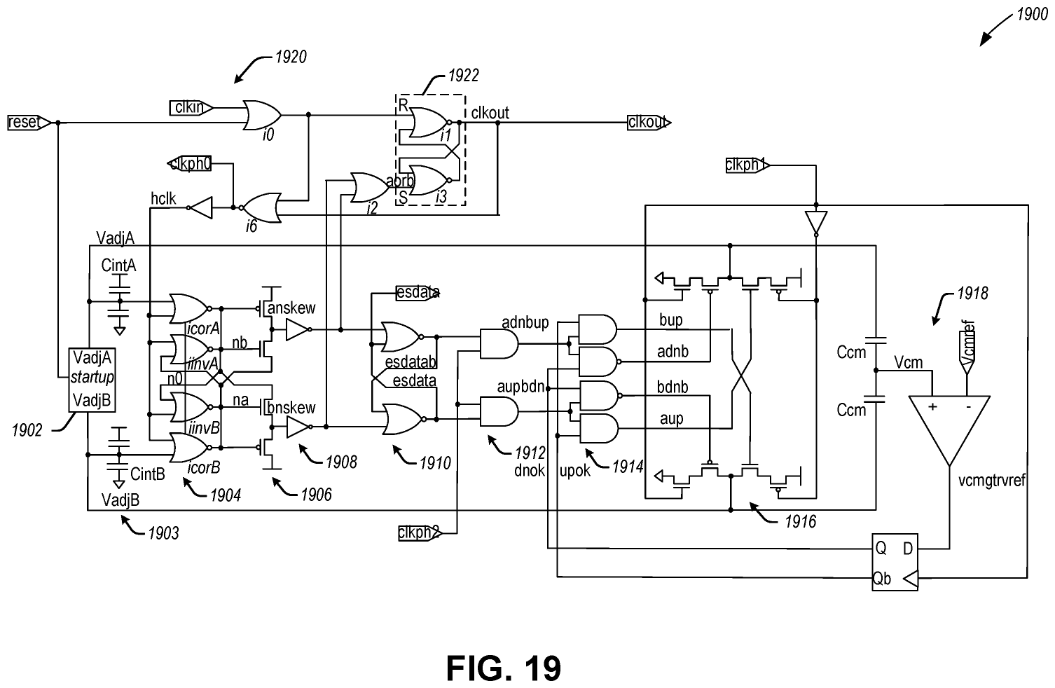

In the second phase, either of the following events can occur, as indicated in Table 2 below. The differential voltage between VadjA and VadjB stored on capacitors CintA and CintB (e.g., as illustrated in FIG. 5A, FIG. 5B, FIG. 5C, FIG. 8, FIG. 10, FIG. 13, and FIG. 19) is either increased or decreased by turning on either mpcpa1 and mncpb1 OR mncpa1 and mpcpb1. The change in voltage in CintA and CintB is caused by charge redistribution.

TABLE 2

| aup | adn | bup | bdn | VadjA | VadjB |
|---|---|---|---|---|---|
| 1 | 0 | 0 | 1 | +delta V | −delta V |
| 0 | 1 | 1 | 0 | −delta V | +delta V |

In some embodiments, other configurations may be used as well (e.g., the differential voltage can be increased by changing the voltage on one of the two capacitors). This “single-ended” control scheme could be used to adjust the differential and common mode voltage independently.

The clocking is two-phase non-overlapping (e.g., the “precharge” phase and the “charge redistribution” phase are separated and do not overlap).

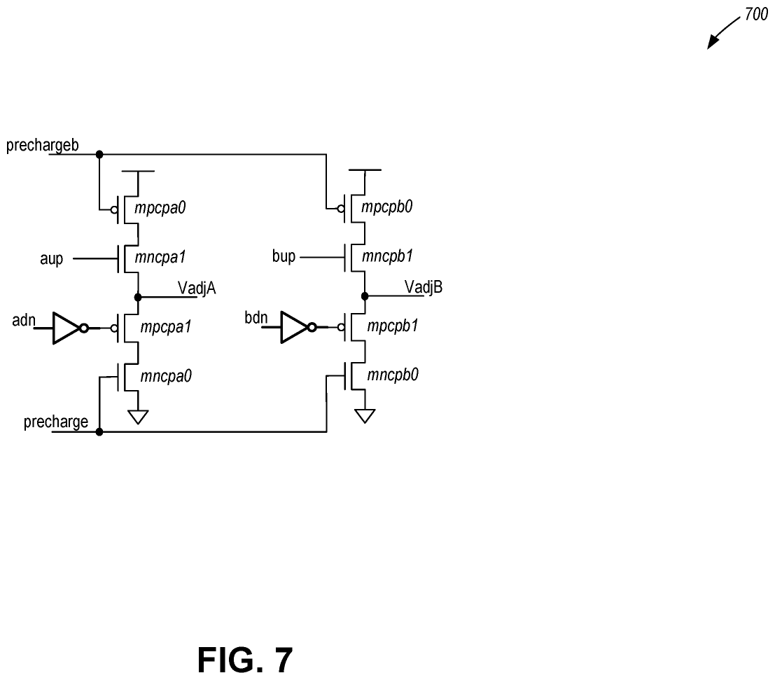

In order to reduce the error caused by leakage through the switched capacitor switches, the circuit in FIG. 7 can be used with the disclosed ES-related configurations.

FIG. 7 is a block diagram of another charge pump 700, in accordance with some embodiments.

In some aspects, charge pump 600 or charge pump 700 can be used with the disclosed ES-related configurations. Referring to FIG. 7, charge pump 700 swaps the switches coupling npa and npb with VadjA and VadjB from PMOS to NMOS and the switches coupling nna and nnb to VadjA and VadjB from NMOS to PMOS. This configuration causes the switches to be reverse-biased when they are OFF and reduces leakage current.

In some aspects, PMOS precharge devices mpcpa0 and mpcpb0 with gates coupled to prechargeb can be swapped with NMOS precharge devices mncpa0 and mncpb0 with gates tied to precharge to reduce leakage current further and to allow even smaller capacitance from the shared diffusion between precharge and switch transistors

FIG. 8 is a block diagram of a closed loop circuit 800 generating entropy source data, in accordance with some embodiments. Referring to FIG. 8, the closed loop circuit 800 includes a bistable circuit 802 (e.g., as illustrated in FIG. 3), a differential buffer 804 (e.g., as illustrated in FIG. 4), inverters 806, SR latch 808 (e.g., as illustrated in FIG. 5B), NAND gates 810, and charge pump 812 (e.g., as illustrated in FIG. 7).

The closed loop circuit 800 connects the charge pump to the heart circuit of FIG. 5B (the clock latch from FIG. 5C is not shown). The two phase clocks for precharge and charge redistribution are inputs pclk and rclk respectively. The relk input is gated by esdata and esdatab to produce the inputs for switching A up and B down or B up and A down, respectively.

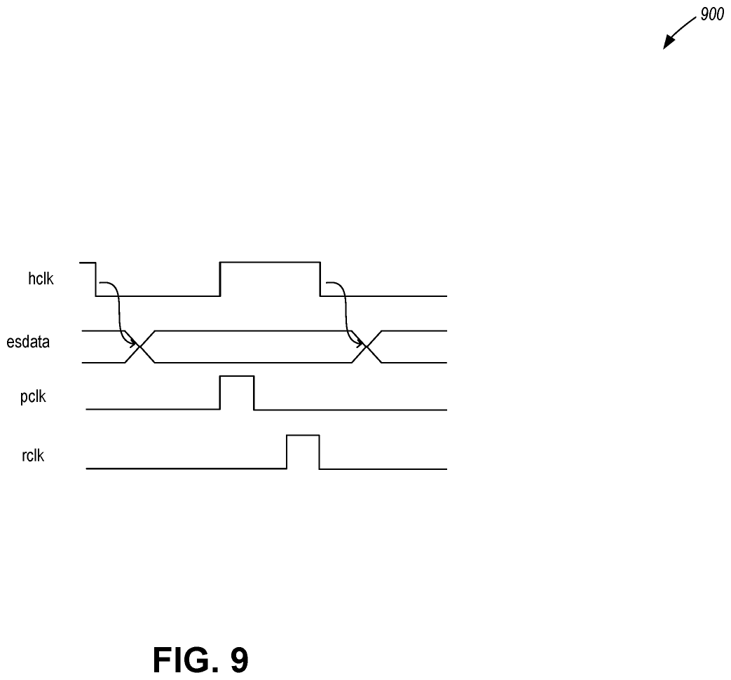

A digital circuit could generate the polk and rclk phases from the input clock hclk. On the falling edge of hclk, after a delay, the esdata and esdatab outputs will be set from the bistable circuit exiting metastability. The rising edge of hclk could be used to generate the pclk and relk phases, so the charge pump adjusts the VadjV and VadjB voltages prior to the subsequent hclk falling edge, as shown in FIG. 9.

FIG. 9 is a signal timing diagram 900 of the signals used in FIG. 8, in accordance with some embodiments.

In some aspects, the entropy source circuit in FIG. 10 can be used instead of an external clock and a two-phase clock generator.

FIG. 10 is a block diagram of a self-oscillating entropy source circuit 1000, in accordance with some embodiments. Referring to FIG. 10, the entropy source circuit 1000 includes input capacitors 1002, a bistable circuit 1004, a differential buffer 1006, inverters 1008, a first SR latch 1010, NAND gates 1012, and a charge pump 1014. The entropy source circuit 1000 further includes self-clocking circuitry such as an oscillator 1016 using a second SR latch 1018.

The entropy source circuit 1000 is self-oscillating due to the inversion between clkin and clkout. In some aspects, the oscillation frequency can be controlled by the variable delays d1 and d2. In addition, the two charge pump phases are generated by the AND gates i4 and i5, which create the precharge and redistribution clocks (pclk and rclk) for the charge pump 1014.

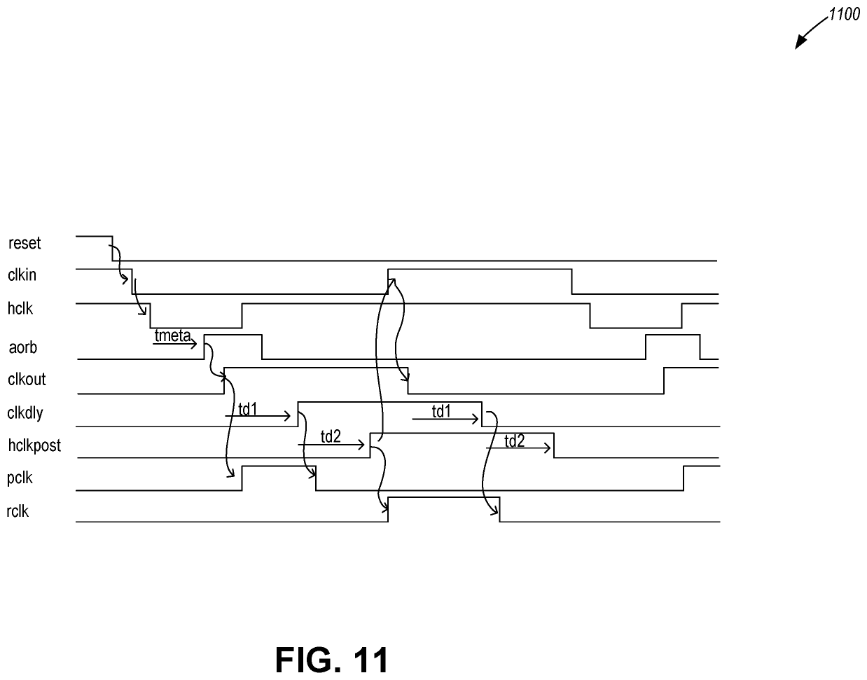

FIG. 11 is a signal timing diagram 1100 of the signals used in FIG. 10, in accordance with some embodiments.

The entropy source circuit 1000 can be configured as a fully functional entropy source. The configuration of the circuit illustrated in FIG. 10 is an example of one of the ways that this circuit can be clocked, and other clocking configurations can be used as well. The bistable heart circuit and charge pump have negative feedback based on the polarity of esdata. This configuration can form an offset cancellation system where VadjA and VadjB are adjusted continuously to cancel the mismatch in the bistable circuit.

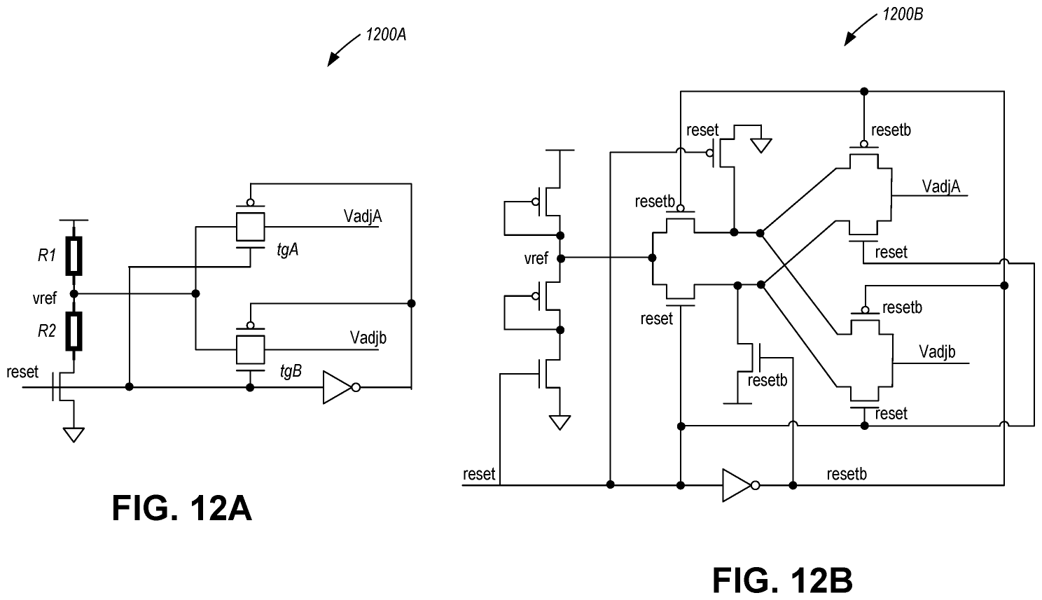

FIG. 12A and FIG. 12B illustrate block diagrams of startup circuits 1200A and 1200B that can be used with the disclosed entropy sources, in accordance with some embodiments.

Because the CintA and CintB caps can be very large and the voltage increments very small, a startup circuit (e.g., startup circuit 1200A or startup circuit 1200B) can be used to initialize the capacitor voltages during reset.

FIG. 12A shows the circuit concept of startup circuit 1200A, which uses a voltage reference coupled to the VadjA and VadjB nodes via MOS passgates. When the reset input is 1, the voltage divider is energized, and the passgates are open. This will set the VadjA and VadjB nodes connected to CintA and CintB to vref. When reset is 0, the passgates are closed, and the NMOS switch turns OFF the voltage reference.

FIG. 12B shows an implementation of a startup circuit 1200B that uses diode-connected PMOS transistors in series for the voltage reference. The startup circuit also uses low leakage passgates, which have an intermediate node pulled to VCC or VSS to reverse bias the PMOS and NMOS passgate transistors respectively when the startup circuit is disabled to lower leakage. This design uses an NMOS device to pull to VCC and a PMOS to pull to VSS, but the opposite polarity devices could be used.

FIG. 13 is a block diagram of an entropy source circuit 1300 using a startup circuit, in accordance with some embodiments. Referring to FIG. 13, the entropy source circuit 1300 includes a startup circuit 1302, input capacitors 1303, a bistable circuit 1304, a differential buffer 1306, inverters 1308, a first SR latch 1310, NAND gates 1312, a charge pump 1314, and clocking circuitry 1316 using a second SR latch 1318.

FIG. 13 shows the entropy source circuit 1300, including the startup circuit 1302, but omitting the self-clocking logic (e.g., as illustrated in FIG. 10). The disclosed self-clocking logic is optional and does not limit the scope of disclosed embodiments.

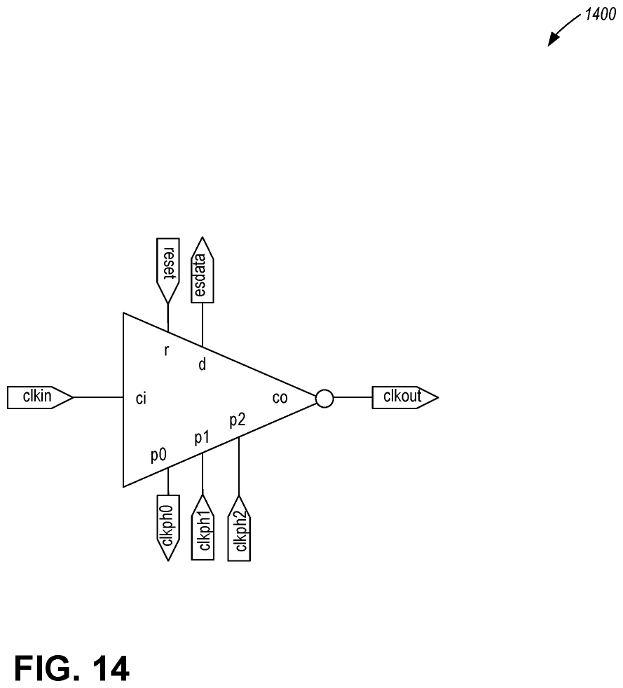

An example symbol view for the entropy source circuit 1300 is shown in FIG. 14. FIG. 14 is a block diagram 1400 of the symbol view for the entropy source of FIG. 13, in accordance with some embodiments. The schematic and symbol use numeric clock phase designations instead of the naming in previous figures, as listed in Table 3 below.

TABLE 3

| Clock Phase | Signal Name | Alternate Name | Purpose |
|---|---|---|---|
| Phase 0 | clkph0 | Inverted “hclk” | Heart clock |
| Phase 1 | clkph1 | pclk | Precharge |
| Phase 2 | clkph2 | rclk | Redistribute |

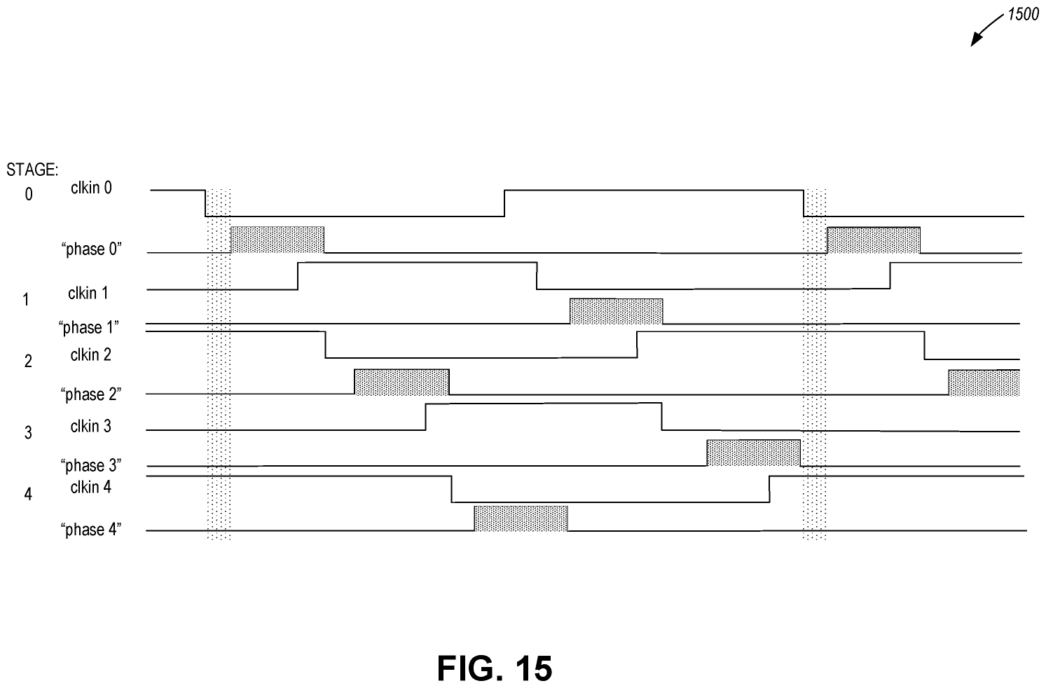

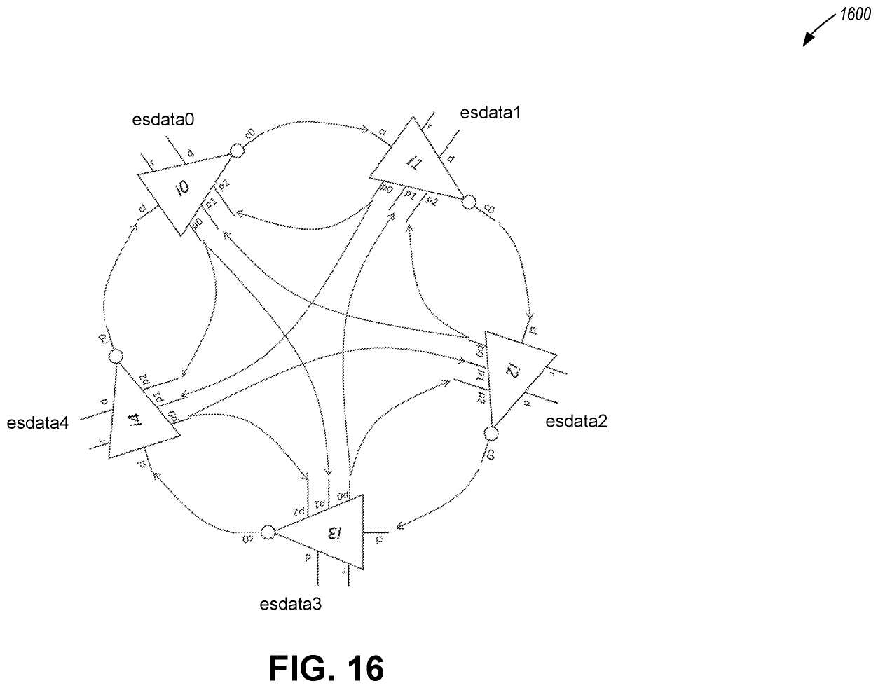

FIG. 15 is a signal timing diagram 1500 for a 5-stage ring topology using a disclosed entropy source, in accordance with some embodiments. FIG. 16 is a block diagram of a 5-stage ring topology 1600 using a disclosed entropy source, in accordance with some embodiments.

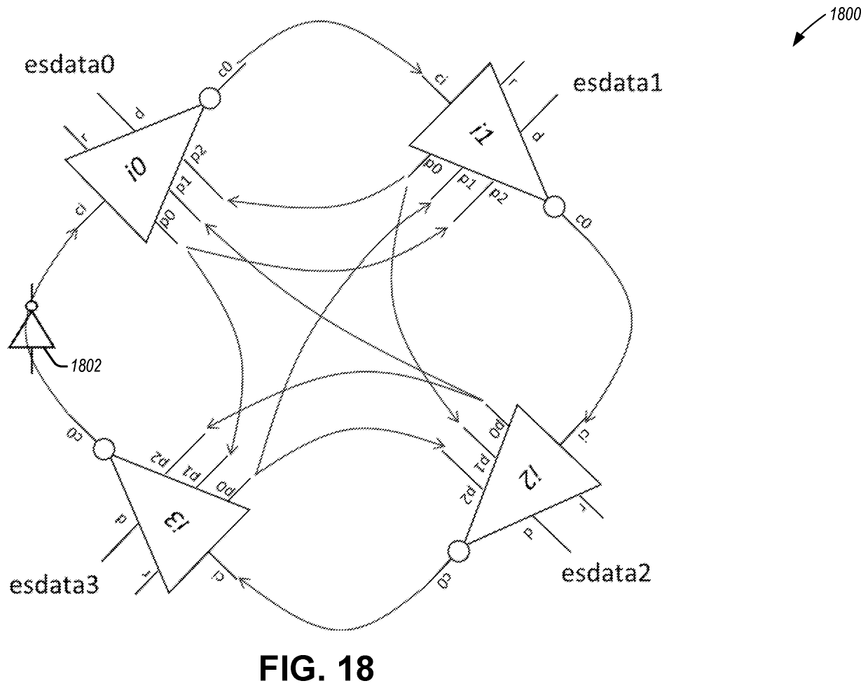

When multiple ES stages (e.g., entropy source circuit 1300) are placed in a ring topology with clkout connecting to the next stage's input clkin, a ring oscillator is formed (e.g., as illustrated in FIG. 16). Because clkin to clkout is inverting, if an even number of stages are used, an inverter (e.g., inverter 1802) is used between the final stages output and the first stages input (e.g., as illustrated in FIG. 18).

FIG. 15 shows the timing for a 5-stage ring (e.g., 5-stage ring topology 1600). The outputs of the input clock (ci) and clkph0 (p0) are shown for each stage. The output clock is not shown because it is just the subsequent stage's input clock. In some aspects, the 5-stage ring topology 1600 generates 5 non-overlapping clock phases from the clkph0 (p0) outputs of the 5 individual stages. FIG. 15 illustrates the 5 clkph0 outputs labeled “phase 0” through “phase 4”.

In some aspects, the clock phases can be used as the clkph1 and clkph2 inputs to the stages in the ring. For example, in the 5-stage ring, each stage can get its clkph1 input from the clkph0 output of the stage two spots downstream in the ring. Each stage can get its clkph2 input from the clkph0 output of the stage one spot downstream in the ring. This is illustrated in FIG. 16 (the reset input of all stages is standard but is not shown as connected in the figure).

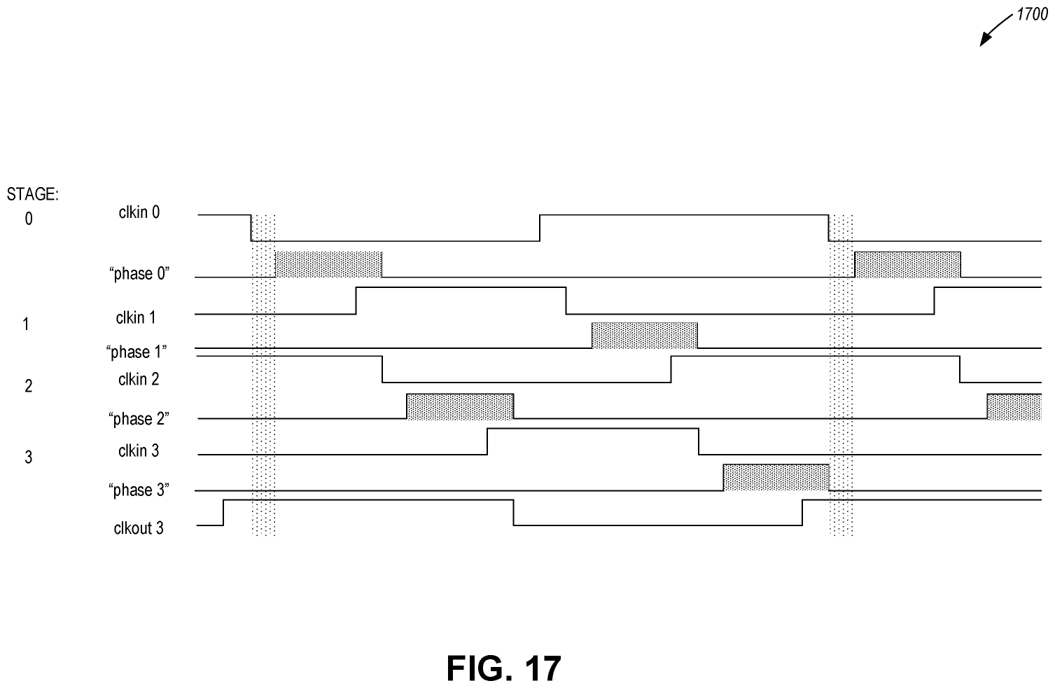

FIG. 17 is a signal timing diagram 1700 for a 4-stage ring topology (e.g., 4-stage ring topology 1800) using a disclosed entropy source, in accordance with some embodiments. FIG. 18 is a block diagram of a 4-stage ring topology 1800 using a disclosed entropy source, in accordance with some embodiments.

Even though 4-stage and 5-stage ring topologies are illustrated in the figures and discussed herein, the disclosure is not limited in this regard, and other ring topologies can be configured as well using the disclosed ES-based techniques. Additionally, there is more than one way to map the clkph1 and clkph2 inputs of each stage to the clkph0 outputs of the stages in the ring. This will be true for larger ring topologies as well.

FIG. 19 is a block diagram of an entropy source circuit 1900 using a capacitive voltage divider for common mode voltage feedback, in accordance with some embodiments. Referring to FIG. 19, the entropy source circuit 1900 includes a startup circuit 1902, input capacitors 1903, a bistable circuit 1904, a differential buffer 1906, inverters 1908, a first SR latch 1910, NAND gates 1912, NAND and AND gates 1914, a charge pump 1916, clocking circuitry 1920 using a second SR latch 1922, and capacitive voltage divider 1918.

In some aspects, the charge pump may not be switched differentially, and a common mode feedback circuit may be used to switch the charge pump single-endedly to adjust differential and common mode voltages simultaneously. More specifically, the entropy source circuit 1900 uses a capacitive voltage divider 1918 between VadjA and VadjB to extract the common mode voltage. A comparator compares this voltage to a reference, which represents the desired common mode voltage. The output of the comparator is latched using the precharge clock phase (clkph1). The output of the comparator may be latched with a different clock signal or not latched at all. This latched value and its complement are used to gate the up and down signals such that if Vcm>Vref, the “dn” input pulses (e.g., adn and bdn) are allowed through. If Vcm<Vref, the “up” pules would be allowed through.

Even though specific clocking schemes and charge pump configurations are discussed herein and illustrated in the figures, the disclosure is not limited in this regard, and other clocking schemes and charge pump configurations can be used with the disclosed ES-based circuits and configurations. For example, the disclosed ES-based circuits and configurations can use different phases, different numbers of stages, and/or different charge pump schemes without changing the nature of the disclosed techniques.

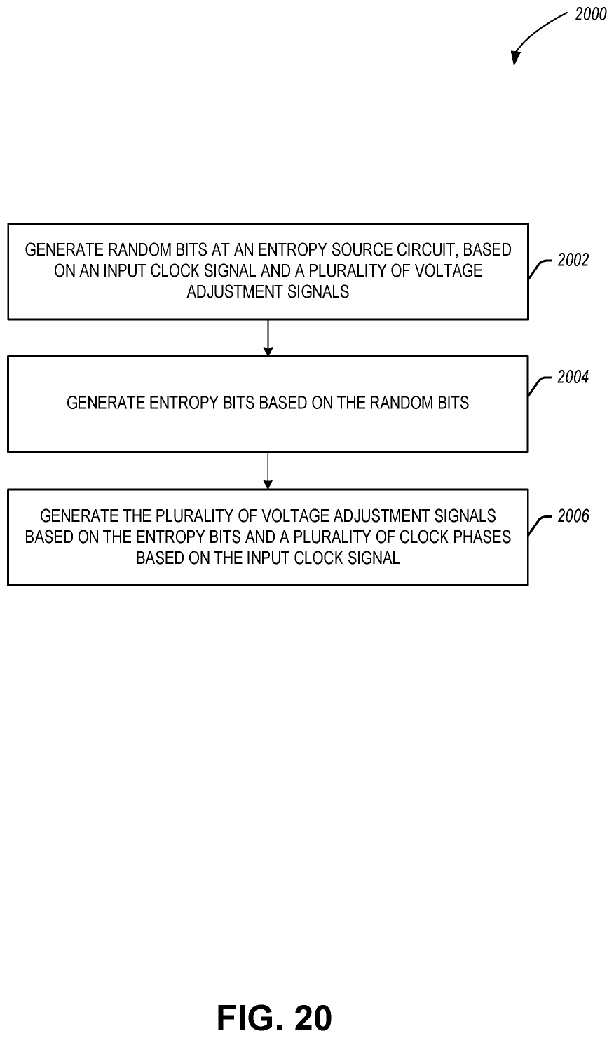

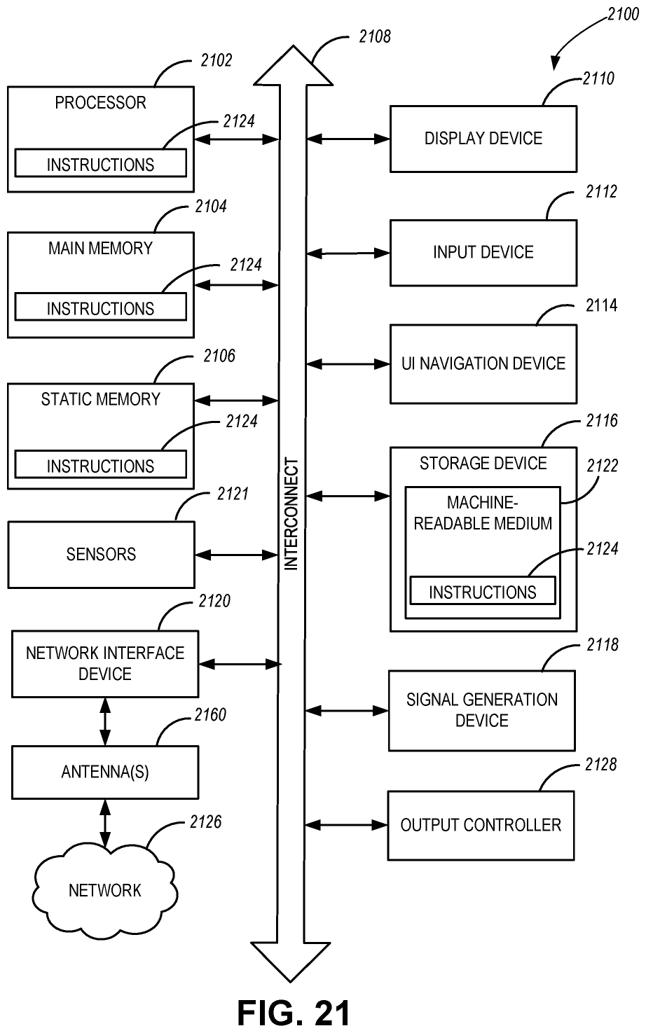

FIG. 20 is a flow diagram of an example method 2000 for generating entropy source data, in accordance with some embodiments. Referring to FIG. 20, method 2000 includes operations 2002, 2004, and 2006, which may be executed by an embedded controller or another processor of a computing device (e.g., hardware processor 2102 of machine 2100 illustrated in FIG. 21, which can include one or more of the circuits discussed in connection with FIGS. 1-19). In some embodiments, one or more of the circuits discussed in connection with FIGS. 1-19 can perform the functionalities listed in FIG. 20, as well as in the examples listed below.

At operation 2002, random bits are generated at an entropy source circuit, based on an input clock signal and a plurality of voltage adjustment signals. For example, the random bits are generated at the output of the inverters 1008 of the entropy source circuit 1000 based on the input clock signal (e.g., hclk generated based on clkin) and voltage adjustment signals (e.g., VadjA and VadjB).

At operation 2004, entropy bits are generated based on the random bits. For example, the entropy bits (e.g., esdata) are generated at the output of the SR latch 1010.

At operation 2006, the plurality of voltage adjustment signals are generated based on the entropy bits and a plurality of clock phases based on the input clock signal. For example, voltage adjustment signals (e.g., VadjA and VadjB) are generated by the charge pump 1014 based on the entropy bits and a plurality of clock phases (e.g., rclk and pclk).

FIG. 21 illustrates a block diagram of an example machine 2100 upon which any one or more of the techniques (e.g., methodologies) discussed herein may perform. In alternative embodiments, the machine 2100 may operate as a standalone device or may be connected (e.g., networked) to other machines. In a networked deployment, machine 2100 may operate in the capacity of a server machine, a client machine, or both in server-client network environments. In an example, machine 2100 may function as a peer machine in a peer-to-peer (P2P) (or other distributed) network environment. The machine 2100 may be a personal computer (PC), a tablet PC, a set-top box (STB), a personal digital assistant (PDA), a portable communications device, a mobile telephone, a smartphone, a web appliance, a network router, switch or bridge, or any other computing device capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. The terms “machine,” “computing device,” and “computer system” are used interchangeably.

Machine (e.g., computer system) 2100 may include a hardware processor 2102 (e.g., a central processing unit (CPU), a graphics processing unit (GPU), a hardware processor core, or any combination thereof), a main memory 2104, and a static memory 2106, some or all of which may communicate with each other via an interlink (e.g., bus) 2108. In some aspects, the main memory 2104, the static memory 2106, or any other type of memory (including cache memory) used by machine 2100 can be configured based on the disclosed techniques or can implement the disclosed memory devices.

Specific examples of main memory 2104 include Random Access Memory (RAM) and semiconductor memory devices, which may include, in some embodiments, storage locations in semiconductors such as registers. Specific examples of static memory 2106 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

Machine 2100 may further include a display device 2110, an input device 2112 (e.g., a keyboard), and a user interface (UI) navigation device 2114 (e.g., a mouse). In an example, the display device 2110, the input device 2112, and the UI navigation device 2114 may be a touchscreen display. The machine 2100 may additionally include a storage device (e.g., drive unit or another mass storage device) 2116, a signal generation device 2118 (e.g., a speaker), a network interface device 2120, and one or more sensors 2121, such as a global positioning system (GPS) sensor, compass, accelerometer, or other sensors. The machine 2100 may include an output controller 2128, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments, the hardware processor 2102 and/or instructions 2124 may comprise processing circuitry and/or transceiver circuitry.

The storage device 2116 may include a machine-readable medium 2122 on which one or more sets of data structures or instructions 2124 (e.g., software) embodying or utilized by any one or more of the techniques or functions described herein can be stored. Instructions 2124 may also reside, completely or at least partially, within the main memory 2104, within static memory 2106, or the hardware processor 2102 during execution thereof by the machine 2100. In an example, one or any combination of the hardware processor 2102, the main memory 2104, the static memory 2106, or the storage device 2116 may constitute machine-readable media.

Specific examples of machine-readable media may include non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine-readable medium 2122 is illustrated as a single medium, the term “machine-readable medium” may include a single medium or multiple media (e.g., a centralized or distributed database and/or associated caches and servers) configured to store instructions 2124.

An apparatus of the machine 2100 may be one or more of a hardware processor 2102 (e.g., a central processing unit (CPU), a graphics processing unit (GPU), a hardware processor core, or any combination thereof), a main memory 2104 and a static memory 2106, one or more sensors 2121, a network interface device 2120, one or more antennas 2160, a display device 2110, an input device 2112, a UI navigation device 2114, a storage device 2116, instructions 2124, a signal generation device 2118, and an output controller 2128. The apparatus may be configured to perform one or more of the methods and/or operations disclosed herein. The apparatus may be intended as a component of machine 2100 to perform one or more of the methods and/or operations disclosed herein and/or to perform a portion of one or more of the methods and/or operations disclosed herein. In some embodiments, the apparatus may include a pin or other means to receive power. In some embodiments, the apparatus may include power conditioning hardware.

The term “machine-readable medium” may include any medium that is capable of storing, encoding, or carrying instructions for execution by machine 2100 and that causes machine 2100 to perform any one or more of the techniques of the present disclosure or that is capable of storing, encoding, or carrying data structures used by or associated with such instructions. Non-limiting machine-readable medium examples may include solid-state memories and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine-readable media may include non-transitory machine-readable media. In some examples, machine-readable media may include machine-readable media that is not a transitory propagating signal.

The instructions 2124 may further be transmitted or received over a communications network 2126 using a transmission medium via the network interface device 2120 utilizing any one of several transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, a cellular network such as 3GPP Fifth Generation New Radio (5G NR) (and beyond) wireless network, among others.

In an example, the network interface device 2120 may include one or more physical jacks (e.g., Ethernet, coaxial, or phone jacks) or one or more antennas to connect to the communications network 2126. In an example, the network interface device 2120 may include one or more antennas 2160 to wirelessly communicate using at least one single-input multiple-output (SIMO), multiple-input multiple-output (MIMO), or multiple-input single-output (MISO) techniques. In some examples, the network interface device 2120 may wirelessly communicate using multiple-user MIMO techniques. The term “transmission medium” shall be taken to include any intangible medium that can store, encode, or carry instructions for execution by the machine 2100 and includes digital or analog communications signals or other intangible media to facilitate communication of such software.

Examples, as described herein, may include, or may operate on, logic or several components, modules, or mechanisms. Modules are tangible entities (e.g., hardware) capable of performing specified operations and may be configured or arranged in a particular manner. In an example, circuits may be arranged (e.g., internally or concerning external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part, all, or any operation described herein. Considering examples in which modules are temporarily configured, each of the modules need not be instantiated at any one moment in time. For example, where the modules comprise a general-purpose hardware processor configured using the software, the general-purpose hardware processor may be configured as respective different modules at separate times. The software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable the performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM), random access memory (RAM), magnetic disk storage media, optical storage media, flash memory, etc.

The above-detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof) or with respect to other examples (or one or more aspects thereof) shown or described herein.

Publications, patents, and patent documents referred to in this document are incorporated by reference herein in their entirety, as though individually incorporated by reference. In the event of inconsistent usage between this document and those documents so incorporated by reference, the usage in the incorporated reference(s) is supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc., are used merely as labels and are not intended to suggest a numerical order for their objects.

The embodiments as described above may be implemented in various hardware configurations that may include a processor for executing instructions that perform the techniques described. Such instructions may be contained in a machine-readable medium such as a suitable storage medium or a memory or other processor-executable medium.

The embodiments as described herein may be implemented in several environments, such as part of a system on chip, a set of intercommunicating functional blocks, or similar, although the scope of the disclosure is not limited in this respect.

Described implementations of the subject matter can include one or more features, alone or in combination, as illustrated below by way of examples.

Example 1 is an apparatus comprising a first OR gate comprising an input terminal coupled to an input clock signal; a second OR gate comprising a first input terminal coupled to an output terminal of the first OR gate; a first pair of NOR gates comprising a first input terminal and a second input terminal coupled to an output terminal of the second OR gate; a second pair of NOR gates comprising a first input terminal and a second input terminal coupled to the output terminal of the second OR gate, the second pair of NOR gates being cross-coupled with the first pair of NOR gates; and a differential buffer comprising a first input terminal and a second input terminal, the first input terminal coupled to a first pair of output terminals of the first pair of NOR gates, and the second input terminal coupled to a second pair of output terminals of the second pair of NOR gates.

In Example 2, the subject matter of Example 1 includes a first inverter comprising an input terminal coupled to a first output of the differential buffer and a second inverter comprising an input terminal coupled to a second output of the differential buffer.

In Example 3, the subject matter of Example 2 includes a first SR latch circuit comprising a first input terminal coupled to an output terminal of the first inverter and a second input terminal coupled to an output terminal of the second inverter.

In Example 4, the subject matter of Example 3 includes, a first NAND gate comprising a first input terminal coupled to a first output terminal of the first SR latch circuit and a second input terminal coupled to a redistribute clock signal.

In Example 5, the subject matter of Example 4 includes a second NAND gate comprising a first input terminal coupled to the redistribute clock signal and a second input terminal coupled to a second output terminal of the first SR latch circuit.

In Example 6, the subject matter of Example 5 includes a charge pump circuit comprising a plurality of switch capacitor resistors, wherein a first input terminal of the charge pump circuit is coupled to an output terminal of the first NAND gate and wherein a second input terminal of the charge pump circuit is coupled to an output terminal of the second NAND gate.

In Example 7, the subject matter of Example 6 includes subject matter where a first output terminal of the charge pump circuit is coupled to a third input terminal of the first pair of NOR gates and wherein a second output terminal of the charge pump circuit is coupled to a third input terminal of the second pair of NOR gates.

In Example 8, the subject matter of Examples 6-7 includes subject matter where a third input terminal of the charge pump circuit is coupled to a precharge clock signal.

In Example 9, the subject matter of Examples 3-8 includes a third OR gate comprising a first input terminal coupled to an output terminal of the first inverter and a second input terminal coupled to an output terminal of the second inverter.

In Example 10, the subject matter of Example 9 includes a second SR latch circuit comprising a first input terminal coupled to the output terminal of the first OR gate and a second input terminal coupled to an output terminal of the third OR gate.

In Example 11, the subject matter of Example 10 includes subject matter where an output terminal of the second SR latch circuit is coupled to a second input terminal of the second OR gate.

In Example 12, the subject matter of Examples 1-11 includes one or more interconnects coupled to the first OR gate, the second OR gate, the first pair of NOR gates, the second pair of NOR gates, the differential buffer, the first inverter, the second inverter, the first SR latch, and the second SR latch.

In Example 13, the subject matter of Examples 1-12 includes subject matter where the apparatus comprises a processor, and wherein the processor includes one or more of the first OR gate, the second OR gate, the first pair of NOR gates, the second pair of NOR gates, the differential buffer, the first inverter, the second inverter, the first SR latch, and the second SR latch.

Example 14 is an apparatus comprising a bistable circuit configured to generate random bits based on an input clock signal and a plurality of voltage adjustment signals; a first latch circuit coupled to the bistable circuit and configured to generate entropy bits based on the random bits; and a charge pump circuit coupled to the latch circuit and configured to generate the plurality of voltage adjustment signals based on the entropy bits, a redistribute clock signal, and a precharge clock signal.

In Example 15, the subject matter of Example 14 includes an oscillator circuit coupled to the bistable circuit and configured to generate the input clock signal, the redistribute clock signal, and the precharge clock signal based on a reset signal.

In Example 16, the subject matter of Example 15 includes a second latch circuit configured to generate an output clock signal based on the input clock signal and an inverted version of the random bits, wherein the redistribute clock signal and the precharge clock signal are based on the output clock signal.

In Example 17, the subject matter of Example 16 includes a plurality of input capacitors configured to store capacitor voltages of the plurality of voltage adjustment signals and a startup circuit coupled to the plurality of input capacitors, wherein the startup circuit is configured to initialize the capacitor voltages of the plurality of input capacitors during a reset associated with the reset signal.

In Example 18, the subject matter of Examples 14-17 includes subject matter where the bistable circuit, the first latch circuit, and the charge pump are configured as a processing stage, wherein the processing stage is coupled in a ring topology with a plurality of other processing stages, and wherein the processing stage is to: generate the precharge clock signal and the redistribute clock signal based on output clock signals generated by at least one of the plurality of other processing stages.

In Example 19, the subject matter of Examples 14-18 includes one or more interconnects coupled to the bistable circuit, the first latch circuit, and the charge pump circuit.

In Example 20, the subject matter of Examples 14-19 includes subject matter where the apparatus comprises a processor, and wherein the processor includes one or more of the bistable circuit, the first latch circuit, and the charge pump circuit.

Example 21 is a method comprising generating random bits at an entropy source circuit based on an input clock signal and a plurality of voltage adjustment signals, generating entropy bits based on the random bits, and generating the plurality of voltage adjustment signals based on the entropy bits and a plurality of clock phases based on the input clock signal.

In Example 22, the subject matter of Example 21 includes configuring the entropy source circuit in a ring topology with a plurality of other entropy source circuits and generating the plurality of clock phases based on output clock signals received from at least one of the plurality of other entropy source circuits.

Example 23 is at least one machine-readable medium including instructions that, when executed by processing circuitry, cause the processing circuitry to perform operations to implement of any of Examples 1-22.

Example 24 is an apparatus comprising means to implement any of Examples 1-22.

Example 25 is a system to implement any of Examples 1-22.

Example 26 is a method to implement any of Examples 1-22.

The above description is intended to be illustrative and not restrictive. For example, the above-described examples (or one or more aspects thereof) may be used in combination with others. Other embodiments may be used, such as by one of ordinary skill in the art upon reviewing the above description. The abstract is to allow the reader to ascertain the nature of the technical disclosure quickly. It is submitted with the understanding that it will not be used to interpret or limit the scope or meaning of the claims. Also, in the above Detailed Description, various features may be grouped to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined regarding the appended claims, along with the full scope of equivalents to which such claims are entitled.

What is claimed is:

1. An apparatus comprising:
a first OR gate comprising an input terminal coupled to an input clock signal;
a second OR gate comprising a first input terminal coupled to an output terminal of the first OR gate;
a first pair of NOR gates comprising a first input terminal and a second input terminal coupled to an output terminal of the second OR gate;
a second pair of NOR gates comprising a first input terminal and a second input terminal coupled to the output terminal of the second OR gate, the second pair of NOR gates being cross-coupled with the first pair of NOR gates; and
a differential buffer comprising a first input terminal and a second input terminal, the first input terminal coupled to a first pair of output terminals of the first pair of NOR gates, and the second input terminal coupled to a second pair of output terminals of the second pair of NOR gates.

2. The apparatus of claim 1, further comprising:
a first inverter comprising an input terminal coupled to a first output of the differential buffer; and
a second inverter comprising an input terminal coupled to a second output of the differential buffer.

3. The apparatus of claim 2, further comprising:
a first SR latch circuit comprising a first input terminal coupled to an output terminal of the first inverter and a second input terminal coupled to an output terminal of the second inverter.

4. The apparatus of claim 3, further comprising:
a first NAND gate comprising a first input terminal coupled to a first output terminal of the first SR latch circuit and a second input terminal coupled to a redistribute clock signal.

5. The apparatus of claim 4, further comprising:
a second NAND gate comprising a first input terminal coupled to the redistribute clock signal and a second input terminal coupled to a second output terminal of the first SR latch circuit.

6. The apparatus of claim 5, further comprising:
a charge pump circuit comprising a plurality of switch capacitor resistors, wherein a first input terminal of the charge pump circuit is coupled to an output terminal of the first NAND gate, and wherein a second input terminal of the charge pump circuit is coupled to an output terminal of the second NAND gate.

7. The apparatus of claim 6, wherein a first output terminal of the charge pump circuit is coupled to a third input terminal of the first pair of NOR gates, and wherein a second output terminal of the charge pump circuit is coupled to a third input terminal of the second pair of NOR gates.

8. The apparatus of claim 6, wherein a third input terminal of the charge pump circuit is coupled to a precharge clock signal.

9. The apparatus of claim 3, further comprising:
a third OR gate comprising a first input terminal coupled to an output terminal of the first inverter and a second input terminal coupled to an output terminal of the second inverter.

10. The apparatus of claim 9, further comprising:
a second SR latch circuit comprising a first input terminal coupled to the output terminal of the first OR gate and a second input terminal coupled to an output terminal of the third OR gate.

11. The apparatus of claim 10, wherein an output terminal of the second SR latch circuit is coupled to a second input terminal of the second OR gate.

12. The apparatus of claim 1, further comprising:
one or more interconnects coupled to the first OR gate, the second OR gate, the first pair of NOR gates, the second pair of NOR gates, and the differential buffer.

13. The apparatus of claim 1, wherein the apparatus comprises a processor, and wherein the processor includes one or more of the first OR gate, the second OR gate, the first pair of NOR gates, the second pair of NOR gates, and the differential buffer.

14. An apparatus comprising:
a bistable circuit configured to generate random bits based on an input clock signal and a plurality of voltage adjustment signals;
a first latch circuit coupled to the bistable circuit and configured to generate entropy bits based on the random bits; and
a charge pump circuit coupled to the latch circuit and configured to generate the plurality of voltage adjustment signals based on the entropy bits, a redistribute clock signal, and a precharge clock signal.

15. The apparatus of claim 14, further comprising:
an oscillator circuit coupled to the bistable circuit and configured to generate the input clock signal, the redistribute clock signal, and the precharge clock signal based on a reset signal.

16. The apparatus of claim 15, wherein the oscillator circuit further comprises:
a second latch circuit configured to generate an output clock signal based on the input clock signal and an inverted version of the random bits, wherein the redistribute clock signal and the precharge clock signal are based on the output clock signal.

17. The apparatus of claim 16, further comprising:
a plurality of input capacitors configured to store capacitor voltages of the plurality of voltage adjustment signals; and
a startup circuit coupled to the plurality of input capacitors, wherein the startup circuit is configured to initialize the capacitor voltages of the plurality of input capacitors during a reset associated with the reset signal.

18. The apparatus of claim 14, wherein the bistable circuit, the first latch circuit, and the charge pump are configured as a processing stage, wherein the processing stage is coupled in a ring topology with a plurality of other processing stages, and wherein the processing stage is to:
generate the precharge clock signal and the redistribute clock signal based on output clock signals generated by at least one of the plurality of other processing stages.

19. A method comprising:
generating random bits at an entropy source circuit, based on an input clock signal and a plurality of voltage adjustment signals;
generating entropy bits based on the random bits; and
generating the plurality of voltage adjustment signals based on the entropy bits and a plurality of clock phases based on the input clock signal.

20. The method of claim 19, further comprising:
configuring the entropy source circuit in a ring topology with a plurality of other entropy source circuits; and
generating the plurality of clock phases based on output clock signals received from at least one of the plurality of other entropy source circuits.
